(19) United States
(12) Patent Application Publication
(10) Pub. No.: US 2018/0095173 A1
(43) Pub. Date: Apr. 5, 2018

(54) RADAR DEVICE AND TARGET DETECTING METHOD

(71) Applicant: FUJITSU TEN LIMITED, Kobe-shi (JP)

(72) Inventor: Yasuhiro KURONO, Kobe-shi (JP)

(73) Assignee: FUJITSU TEN LIMITED, Kobe-shi (JP)

(21) Appl. No.: 15/722,422

(22) Filed: Oct. 2, 2017

(30) Foreign Application Priority Data
Oct. 5, 2016 (JP) 2016-197532

(51) Int. Cl. G01S 13/93; B60W 30/08; G01S 17/42; G06K 9/00; G08G 1/16

(52) U.S. Cl. CPC G01S 13/931; B60W 30/08; G08G 1/16; G06K 9/00805; G01S 17/42

(57) ABSTRACT

There is provided a radar device. A transmitting unit transmits chirp waves based on a transmission signal whose frequency continuously increases or decreases. A receiving unit outputs reception signals based on reflected waves of the chirp waves from a target. A transmission control unit controls the transmitting unit to transmit a predetermined number of the chirp waves in a first transmission period, and then transmit the chirp waves more than the predetermined number in a second transmission period. A generating unit generates beat signals from the transmission signal and the reception signals. A signal processing unit derives a distance to the target based on the beat signals generated in the first transmission period, determine a distance range limited based on the derived distance, and derive the distance and a relative velocity to the target based on the beat signals generated in the second transmission period within the distance range.

### CROSS-REFERENCE TO RELATED APPLICATIONS

This application is based on and claims priority from Japanese Patent Application No. 2016-197532 filed on Oct. 5, 2016.

### TECHNICAL FIELD

The present invention relates to a radar device and a target detecting method.

### BACKGROUND

Recently, as a radar device for detecting targets, there is proposed an FCM (Fast Chirp Modulation) type radar device for detecting the distance and relative velocity between the radar device and each target by transmitting chirp waves whose frequency continuously increases or decreases (see Patent Document 1 for instance).

An FCM system is a system for generating chirp waves on the basis of a transmission signal and detecting the distances and relative velocities to targets on the basis of the frequencies and phase variations of beat signals generated from the transmission signal and reception signals obtained by receiving reflected waves of the chirp waves from the targets.

Patent Document 1: Japanese Patent Application Publication No. 2016-003873A

The above-mentioned FCM type radar device performs a two-dimensional FFT process on beat signals. The radar device stores information representing the results of the first FFT process in a memory, and performs the second FFT process on the basis of the information stored in the memory. Therefore, for example, if a transmission wave output time is set to be long in order to increase velocity resolution, the memory capacity of the memory for storing the results of the FFT process increases.

### SUMMARY

It is therefore an object of the present invention to provide a radar device and a target detecting method capable of improving the accuracy of target detection while suppressing an increase in the memory capacity of a memory for a target detecting process.

According to an aspect of the embodiments of the present invention, there is provided a radar device comprising a transmitting unit, a receiving unit, a transmission control unit, a generating unit, and a signal processing unit. The transmitting unit is configured to transmit chirp waves on the basis of a transmission signal whose frequency continuously increases or decreases. The receiving unit is configured to output reception signals based on reflected waves of the chirp waves from a target. The transmission control unit is configured to control the transmitting unit to transmit a predetermined number of chirp waves in a first transmission period, and then control the transmitting unit to transmit the chirp waves more than the predetermined number in a second transmission period. The generating unit is configured to generate beat signals from the transmission signal and the reception signals. The signal processing unit is configured to derive a distance to the target on the basis of the beat signals generated in the first transmission period by the generating unit, determine a distance range limited on the basis of the derived distance, and derive the distance and a relative velocity to the target on the basis of the beat signals generated in the second transmission period by the generating unit within the distance range.

According to the aspect of the embodiments of the present invention, it is possible to improve the accuracy of the target detection while suppressing an increase in the memory capacity of the memory for the target detecting process.

### BRIEF DESCRIPTION OF THE DRAWINGS

In the accompanying drawings:

FIG. 1A is a view illustrating an example of the positional relation between a radar device according to an embodiment and a target;

FIG. 1B is a view for explaining a target detecting process which is performed by the radar device according to the embodiment;

FIG. 2 is a view illustrating the configuration of the radar device according to the embodiment;

FIG. 3 is a view illustrating an example of the relation of the frequency of a transmission signal, the frequency of a reception signal, and beat frequency;

FIG. 4 is a view illustrating another example of the relation of the frequency of a transmission signal, the frequency of a reception signal, and beat frequency;

FIG. 5 is a view illustrating an example of the state of a transmission wave which is output from a transmitting unit by a transmission control unit;

FIG. 6 is a view illustrating a result obtained by performing an FFT process on a beat signal;

FIG. 7 is a view illustrating an example of results obtained by performing an FFT process on temporally consecutive beat signals and phase variation in peaks between the beat signals;

FIG. 8 is a view illustrating an example of the configuration of a frequency analyzing unit;

FIG. 9 is a view illustrating the relation between distance bins and individual beat signals;

FIG. 10 is a view illustrating the relation between distance bins and velocity bins;

FIG. 11 is a view illustrating the relation between peak positions and a determined range;

FIG. 12 is a flow chart illustrating an example of a processing procedure which is performed by a signal processing unit;

FIG. 13 is a flow chart illustrating an example of the flow of a process of STEP S12 shown in FIG. 12; and

FIG. 14 is a flow chart illustrating an example of the flow of a process of STEP S13 shown in FIG. 12.

### DETAILED DESCRIPTION OF THE EMBODIMENTS

Hereinafter, an embodiment of a radar device and a target detecting method according to the present invention will be described in detail with reference to the accompanying drawings. However, the present invention is not limited by the following embodiment.

[1. Target Detecting Method Performed by Radar Device]

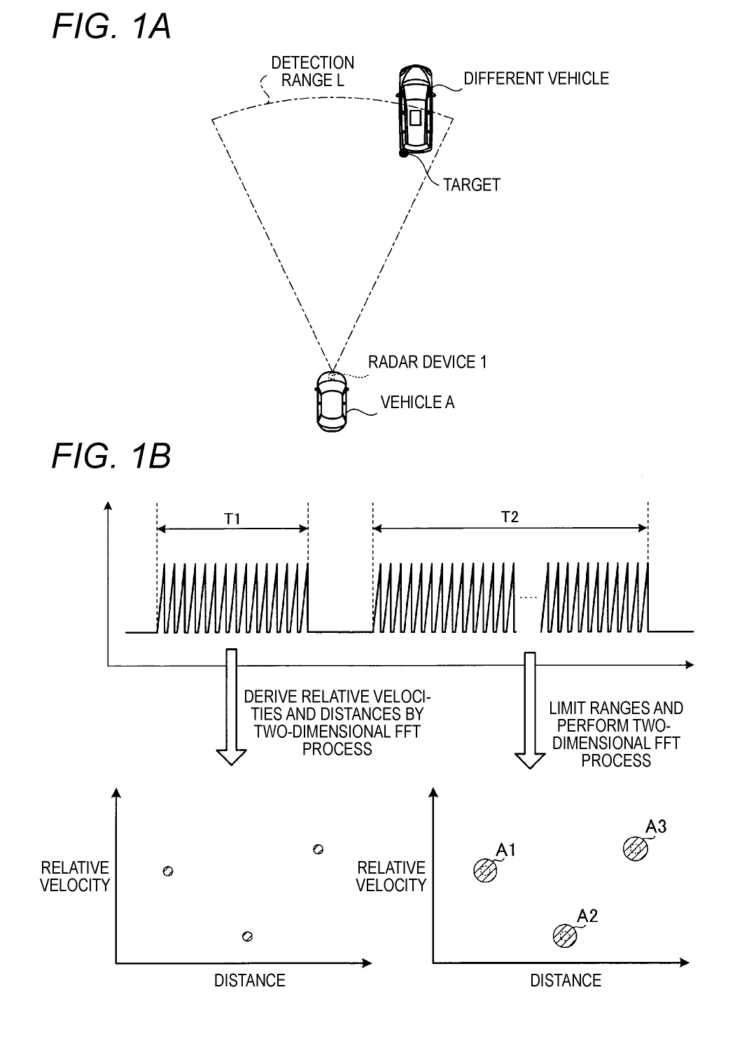

FIG. 1A is a view illustrating an example of the positional relation between a radar device mounted on a vehicle and a target. As shown in FIG. 1A, a radar device 1 according to an embodiment is mounted on a vehicle A such as an automobile, and detects targets (for example, other vehicles, pedestrians, and still objects such as guardrails) in front.

The radar device 1 is an FCM (Fast Chirp Modulation) type radar device configured to detect the distance and relative velocity of each target existing in a detection range L by transmitting chirp waves whose frequency continuously increases or decreases.

The radar device 1 detects the distances and relative velocities between the radar device and targets by generating chirp waves based on a transmission signal, and receiving reflected waves of the chirp waves from the targets, as reception signals, and generating beat signals with respect to the chirp waves on the basis of the transmission signals and the reception signals, and performing two-dimensional fast Fourier transform processes (hereinafter, referred to as two-dimensional FFT processes) on the beat signals.

During two-dimensional FFT processes, the results which are obtained by performing first fast Fourier transform processes (hereinafter, referred to as FFT processes) on a plurality of beat signals are stored in association with the beat signals, respectively. The results of the first FFT processes are frequency spectra of the beat signals, and are the power values (levels) of the frequencies (frequency bins to be described below) of the beat signals, respectively. Thereafter, second FFT processes are performed on the results of the first FFT processes. Therefore, as the results of the second FFT processes, frequency spectra which are frequency distributions showing temporal variations of the power values (levels) of the frequencies (the frequency bins to be described below) in the frequency spectra of the plurality of temporally consecutive beat signals are obtained.

If the number of chirp waves (hereinafter, also referred to as the number of chirps) to be transmitted is increased, it is possible to improve velocity resolution which is the accuracy of detection on the relative velocities of targets, but the number of first FFT processes increases in proportion to the increase in the number of chirps. Therefore, the memory capacity for storing the results of the FFT processes increases.

For this reason, the radar device 1 first roughly detects the distances and relative velocities of targets on the basis of beat signals corresponding to a small number of chirp waves, and determines limited ranges on the basis of the detected rough distances and the detected rough relative velocities, and then performs two-dimensional FFT processes on beat signals corresponding to more chirp waves in the limited ranges. Therefore, it is possible to suppress an increase in the memory capacity of the memory for storing the results of two-dimensional FFT processes, and it is possible to suppress an increase in usage of the memory in target detecting processes.

Also, it is only needed that it is possible to determine limited ranges based on detected rough distances and detected rough relative velocities, and store the results of two-dimensional FFT processes obtained in the limited ranges. Therefore, it is also possible to perform two-dimensional FFT processes in the full range, and acquire the results of two-dimensional FFT processes on limited range based on detected rough distances and detected rough relative velocities, as objects to be stored in the memory. This point is the same in the following description.

FIG. 1B is a view for explaining a target detecting process which is performed by the radar device 1. As shown in FIG. 1B, the radar device 1 transmits a predetermined number of chirp waves in a first transmission period T1, and then transmits chirp waves more than the predetermined number in a second transmission period T2.

The radar device 1 generates beat signals on the basis of a transmission signal and reception signals of the first transmission period T1, and performs two-dimensional FFT processes on the beat signals, thereby deriving the distance and relative velocity of individual targets. The example shown in FIG. 1B shows that rough distances and rough relative velocities of three targets are derived by performing two-dimensional FFT processes on beat signals of the first transmission period T1.

In the first transmission period T1, since the number of chirps is small, the distances and relative velocities which are detected on the basis of a plurality of beat signals have low detection accuracy; however, the number of beat signals which are objects of two-dimensional FFT processes is small. Therefore, it is possible to suppress an increase in the memory capacity of the memory for storing the calculation results of FFT processes on the beat signals.

Subsequently, the radar device 1 generates beat signals on the basis of a transmission signal and reception signals of the second transmission period T2, and performs two-dimensional FFT processes on the beat signals. At this time, the radar device 1 performs two-dimensional FFT processes on three limited ranges A1 to A3 including the distances and relative velocities of the three detected targets as shown in FIG. 1B. In the example shown in FIG. 1B, the number of targets which are detected depends the number of targets existing in the detection range L.

In the two-dimensional FFT process, a limited distance range and a limited relative velocity range are determined as objects to be processed. Therefore, an increase in the memory capacity of the memory for storing the calculation results of the two-dimensional FFT process is suppressed. Therefore, it is possible to suppress an increase in usage of memory in the target detecting process, and improve velocity resolution by setting the second transmission period T2 to be long. Also, the radar device 1 can determine at least one of a limited distance range and a limited relative velocity range to be subjected to two-dimensional FFT processes. Hereinafter, an example of the configuration of the radar device 1 according to the embodiment will be described in detail.

[2. Example of Configuration of Radar Device 1]

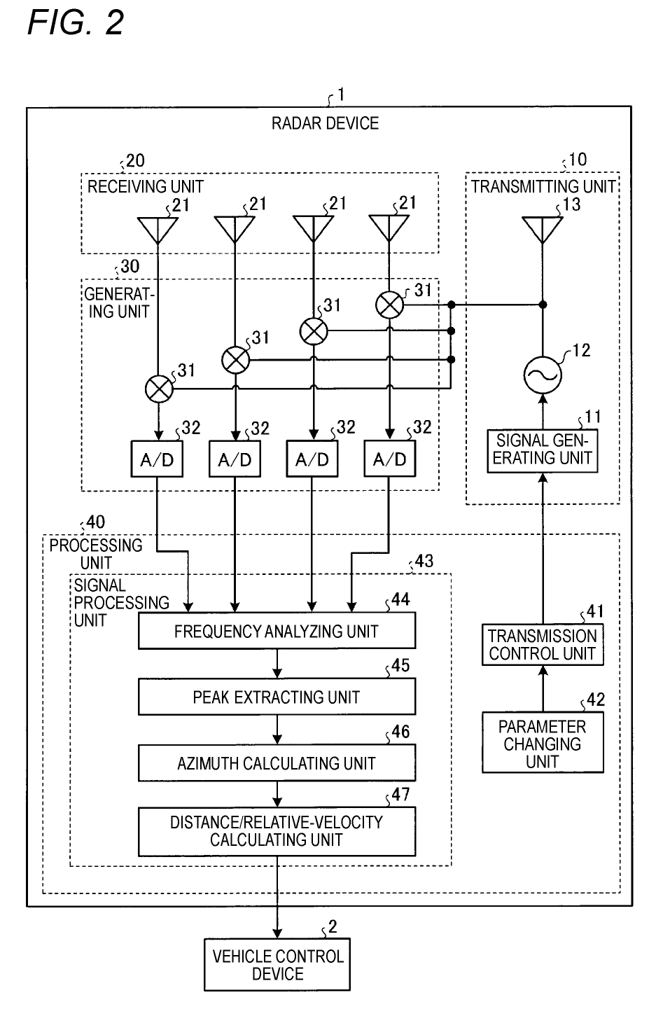

FIG. 2 is a view illustrating the configuration of the radar device 1 according to the embodiment. As shown in FIG. 2, the radar device 1 includes a transmitting unit 10, a receiving unit 20, a generating unit 30, and a processing unit 40, and is connected to a vehicle control device 2 for controlling behavior of the vehicle A.

The vehicle control device 2 performs vehicle control on a pre-crash safety system (PCS), an AEB (Advanced Emergency Braking) system, and the like, on the basis of the results of target detection of the radar device 1. However, the radar device 1 may be used for various uses (such as monitoring of aircrafts and vessels) other than an in-vehicle radar device.

[2.1. Transmitting Unit 10]

The transmitting unit 10 includes a signal generating unit 11, an oscillator 12, and a transmission antenna 13. The signal generating unit 11 generates a modulation signal whose voltage varies in a saw-tooth wave shape, and supplies the modulation signal to the oscillator 12. The oscillator 12 generates transmission signals ST which are chirp signals whose frequencies increase as time goes on, with a predetermined period Tc (hereinafter, referred to as a chirp period Tc, on the basis of the modulation signal generated by the signal generating unit 11, and outputs the transmission signals to the transmission antenna 13.

The transmission antenna 13 converts the transmission signals ST received from the oscillator 12, into transmission waves SW, and outputs the transmission waves SW to the outside of the vehicle A. The transmission waves SW which are output by the transmission antenna 13 are chirp waves whose frequencies increase with the chirp period Tc as time goes on. The transmission waves SW transmitted forward from the vehicle A through the transmission antenna 13 are reflected from targets of other vehicles and so on, thereby becoming reflected waves.

[2.2. Receiving Unit 20]

The receiving unit 20 includes a plurality of receiving antennae 21 forming an array antenna. The individual receiving antennae 21 receives reflected waves from targets, as reception waves RW, and converts the reception waves RW into reception signals SR, and outputs the reception signals to the generating unit 30. Also, the number of receiving antennae 21 shown in FIG. 2 is four; however, it may be three or less, or five or more.

[2.3. Generating Unit 30]

The generating unit 30 generates beat signals SB from the transmission signals ST and the reception signals SR. The generating unit 30 includes a plurality of mixer 31 and a plurality of A/D converters 32. A mixer 31 and an A/D converter 32 are provided for each receiving antenna 21.

The reception signals SR output from the receiving antennae 21 are amplified by amplifiers (not shown in the drawings) (for example, low-noise amplifiers), and then are input to the mixers 31. The mixers 31 partially mix the transmission signals ST and the reception signals SR, and remove unnecessary signal components, thereby generating beat signals SB, and output the beat signals to the A/D converters 32.

In this way, the beat signals SB having beat frequencies f_{SB} (=f_{ST}−f_{SR}) which are the differences between the frequency f_{ST} (hereinafter, referred to as the transmission frequency f_{ST}) of the transmission signals ST and the frequencies (hereinafter, referred to as reception frequencies f_{SR}) of the reception signals SR are generated. The A/D converters 32 convert the beat signals SB generated by the mixers 31, into digital signals, and then output the digital signals to the processing unit 40.

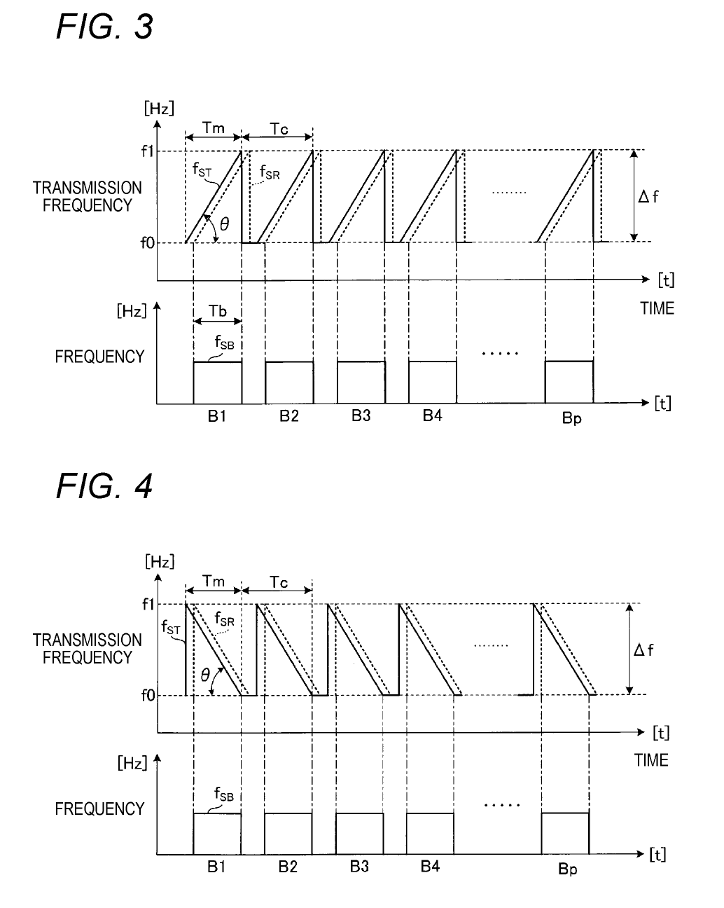

FIG. 3 is a view illustrating an example of the relation of the transmission frequency f_{ST}, a reception frequency f_{SR}, and a beat frequency f_{SB}. As shown in FIG. 3, a beat signal SB is generated on the basis of each chirp wave. Also, here, a beat signal SB which is obtained by the first chirp wave is denoted by “B1”, and a beat signal SB which is obtained by the second chirp wave is denoted by “B2”, and a beat signal SB which is obtained by the p-th chirp wave is denoted by “Bp”.

Also, in the example shown in FIG. 3, in each chirp wave, the transmission frequency f_{ST} has a saw-tooth wave shape in which the transmission frequency increases with a slope θ (=(f1−f0)/Tm) from a reference frequency f0 with time, and if the transmission frequency reaches a maximum frequency f1, it returns to the reference frequency f0 in a short time.

Also, as shown in FIG. 4, in each chirp wave, the transmission frequency f_{ST} may have a saw-tooth wave shape in which a transmission frequency reaches a maximum frequency f1 from the reference frequency f0 in a short time and decreases with a slope θ (=(f1−f0)/Tm) from the maximum frequency f1 to the reference frequency f0 with time. FIG. 4 is a view illustrating another example of a transmission frequency f_{ST}, a reception frequency f_{SR}, and a beat frequency f_{SB}.

[2.4. Processing Unit 40]

The processing unit 40 includes a transmission control unit 41, a parameter changing unit 42, and a signal processing unit 43. The signal processing unit 43 includes a frequency analyzing unit 44, a peak extracting unit 45, an azimuth calculating unit 46, and a distance/relative-velocity calculating unit 47. The processing unit 40 is, for example, a micro computer including a central processing unit (CPU), a read only memory (ROM), a random access memory (RAM), an input/output port, and so on, and controls the whole of the radar device 1.

The CPU of the micro computer reads out programs from the ROM, and executes the programs, thereby functioning as the transmission control unit 41, the parameter changing unit 42, and the signal processing unit 43. However, all of the transmission control unit 41, the parameter changing unit 42, and the signal processing unit 43 can also be configured with hardware such as an application specific integrated circuit (ASIC) and a field programmable gate array (FPGA).

The processing unit 40 performs processing in a processing mode selected from a first processing mode and a second processing mode to be described below. Selection of a processing mode is performed, for example, on the basis of contents input to an input unit (not shown in the drawings). Also, the processing unit 40 can select a processing mode on the basis of a target detection state (for example, the number of targets and the sizes of targets), the running state of the vehicle A (for example, the velocity of the vehicle A and the type of the road where the vehicle is running), and so on.

[2.4.1. Transmission Control Unit 41]

The transmission control unit 41 controls the signal generating unit 11 of the transmitting unit 10 such that the signal generating unit 11 outputs the modulation signal whose voltage varies in a saw-tooth shape to the oscillator 12. As a result, transmission signals ST whose frequency varies as time goes on are output from the oscillator 12 to the transmission antenna 13.

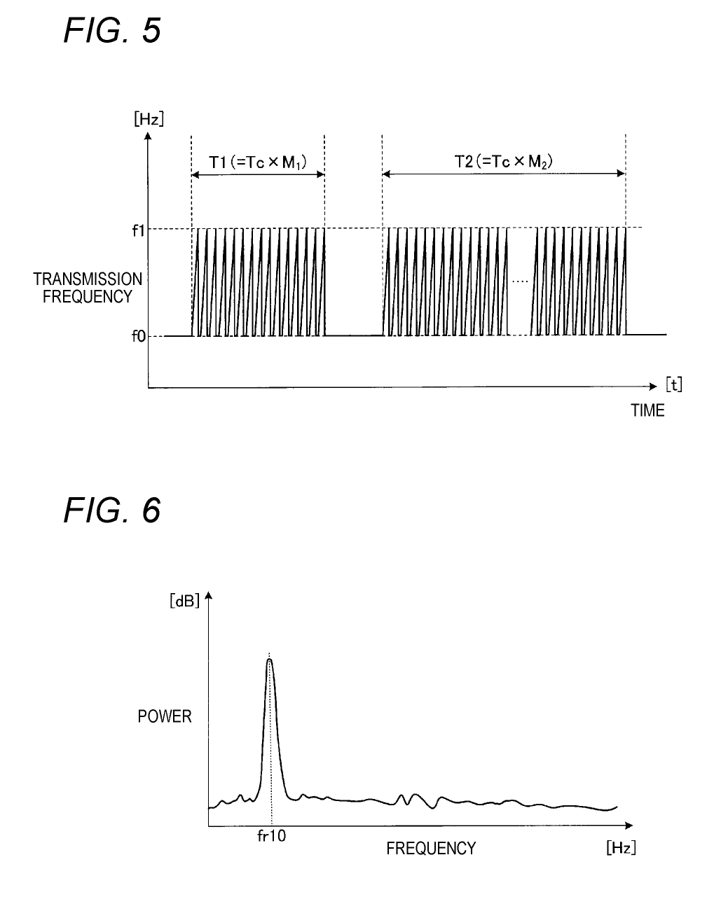

FIG. 5 is a view illustrating an example of the state of a transmission wave which is output from the transmitting unit 10 by the transmission control unit 41. As shown in FIG. 5, the transmission control unit 41 repeatedly performs a process of controlling the signal generating unit 11 such that, in a first transmission period T1 (=Tc×M₁), M₁-number of chirp waves are transmitted, and in the subsequent second transmission period T2 (=Tc×M₂), M₂-number of chirp waves are transmitted (wherein, M₂>M₁). The modulation width Δf of chirp waves can be expressed as Δf=f1−f0.

[2.4.2. Parameter Changing Unit 42]

The parameter changing unit 42 can change parameters (hereinafter, referred to as transmission parameters) necessary for the transmission control unit 41 to control the signal generating unit 11.

For example, the parameter changing unit 42 can change the transmission parameters on the basis of the target detection state of the radar device 1, the running state of the vehicle A (for example, the velocity of the vehicle A and the type of the road where in the vehicle is running), and so on. Also, the processing unit 40 can change the transmission parameters on the basis of contents input to the input unit (not shown in the drawings) and the state of the surroundings of the vehicle (for example, weather and a road congestion situation).

The transmission parameters are, for example, the first transmission period T1, the second transmission period T2, the modulation width Δf of chirp waves, and so on. The parameter changing unit 42 can change the first transmission period T1 depending on the first processing mode and the second processing mode. For example, the parameter changing unit 42 can set a first transmission period T1 for the second processing mode shorter than a first transmission period T1 for the second processing mode.

[2.4.3. Frequency Analyzing Unit 44]

The frequency analyzing unit 44 performs fast Fourier transform processes (hereinafter, referred to as an FFT processes) on beat signals SB output from each A/D converter 32. As the results of the FFT processes, the levels and phases of the signals at frequency bins set at intervals of a frequency according to frequency resolution are extracted. Also, with respect to a description of the frequency analyzing unit 44, hereinafter, FFT processes on beat signals SB which are output from an arbitrary A/D converter 32 will be mainly described.

As described above, transmission waves SW based on the transmission signals ST are transmitted from the transmission antenna 13, and the transmission waves SW are reflected from targets, thereby becoming reflected waves, and the reflected waves are received as reception waves RW by the receiving antennae 21, and are converted into reception signals SR, which are output. A period from when the transmission wave SW is transmitted from the transmission antenna 13 to when the reception signals SR are output are proportional to the distances between the radar device 1 and the targets, and the frequencies of the beat signals SB, that is, the beat frequencies f_{SB} are proportional to the distances between the radar device 1 and the targets (hereinafter, referred to as the distances of the targets).

Therefore, the frequency spectra of the beat signals SB generated by performing FFT processes on the beat signals SB have peaks at frequency bins (hereinafter, also referred to as distance bins fr) corresponding to the distances of the targets. Therefore, it is possible to specify the distance bins fr at which the peaks exist, thereby capable of detecting the distances of the targets.

Also, the total number of distance bins fr in the FFT processes of the frequency analyzing unit 44 is denoted by m (m is a natural number), and the distance bins fr are denoted by fr1 to frm, in order from the lowest frequency to the highest frequency, respectively. For example, a distance bin fr having the lowest frequency is fr1, and a distance bin fr having the second-lowest frequency is fr2, and a distance bin fr having the highest frequency is frm.

FIG. 6 is a view illustrating a result obtained by performing an FFT process on one beat signal SB (for example, B1 shown in FIG. 4), and shows frequency on the horizontal angle, and shows the magnitude of power on the vertical axis. The example shown in FIG. 6, shows that a peak appears at a distance bin fr10 and a target exists at a distance corresponding to the distance bin fr10.

However, in a case where the relative velocity between a target and the radar device 1 is zero, since Doppler components do not occur in reception signals SR, and reception signals SR corresponding to individual chirp waves have the same phase, the phases of individual beat signals SB have the same phase. Meanwhile, in a case where the relative velocity between a target and the radar device 1 is not zero, since Doppler components occur in reception signals SR, and reception signals SR corresponding to individual chirp waves have different phases, in temporally consecutive beat signals SB, phase variation based on Doppler frequencies appears.

Like this, in the case where the relative velocity between a target and the radar device 1 is not zero, at peaks of beat signals SB corresponding to the same target, phase variation based on Doppler frequencies appears. Therefore, frequency spectra having peaks at frequency bins related to Doppler frequencies can be obtained by performing FFT processes on individual beat signals SB, thereby obtaining frequency spectra, and arranging the frequency spectra in chronological order, and performing second FFT processes. The relative velocities of the targets can be detected by detecting the frequency bins (hereinafter, also referred to as velocity bins) at which the peaks appear are detected.

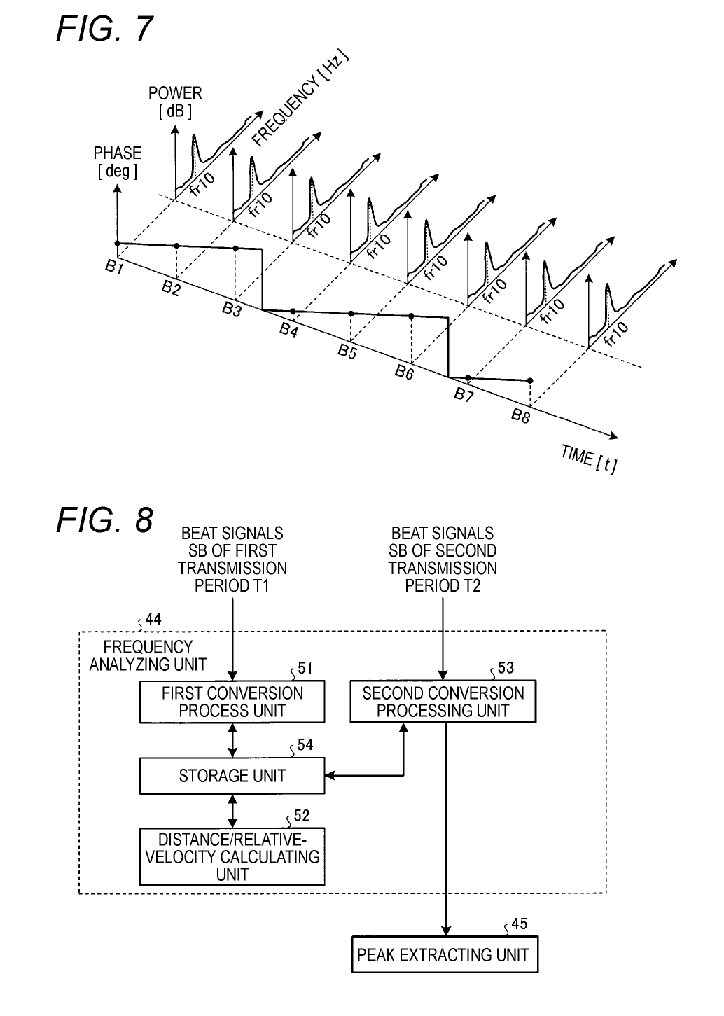

FIG. 7 is a view illustrating an example of the results of FFT processes on temporally consecutive beat signals SB (B1 to B8) and phase variation in the peaks of the beat signals SB. The example shown in FIG. 7 shows that peaks exist at the distance bin fr10 and the phases of the peaks vary.

As described above, it is possible to detect the distances and relative velocities of targets by performing two FFT processes on each of beat signals SB, and detecting distance bins and velocity bins at which peaks exist. Also, it is assumed that the total number of velocity bins fv in FFT processes of the frequency analyzing unit 44 is n (n is a natural number), and the velocity bins fv are expressed by fv1 to fvn in order from the lowest frequency to the highest frequency. For example, a velocity bin fv having the lowest frequency is fv1, and a velocity bin fv having the second-lowest frequency is fv2, and a velocity bin fv having the highest frequency is fvn.

FIG. 8 is a view illustrating an example of the configuration of the frequency analyzing unit 44. As shown in FIG. 8, the frequency analyzing unit 44 includes a first conversion process unit 51 (an example of a first processing unit), a distance/relative-velocity calculating unit 52 (an example of a first deriving unit), a second conversion processing unit 53 (an example of a second processing unit), and a storage unit 54 (an example of a memory).

[2.4.3.1. First Conversion Process Unit 51]

The first conversion process unit 51 performs FFT processes on M₁-number of beat signals SB generated with respect to each receiving antenna 21 in a first transmission period T1 by the generating unit 30.

In a case where the processing unit 40 is in the first processing mode, the first conversion process unit 51 performs two-dimensional FFT processes on the M₁-number of beat signals SB obtained in the first transmission period T1. Meanwhile, in a case where the processing unit 40 is in the second processing mode, the first conversion process unit 51 performs first FFT processes (one-dimensional FFT processes) on the M₁-number of beat signals SB obtained in the first transmission period T1.

First, processing in the first processing mode will be described. In the first processing mode, the first conversion process unit 51 performs first FFT processes (one-dimensional FFT processes) on the M₁-number of beat signals SB of the first transmission period T1, respectively, and stores the results of the FFT processes in the storage unit 54, and performs second FFT processes (one-dimensional FFT processes) on the results of the first FFT process.

For example, the first conversion process unit 51 performs a first FFT process on each distance bin fr (fr1 to frm) of each beat signal SB by calculation of the following Expression 1. Also, “f(x)” is a value (an instantaneous value) which is the result of the x-th A/D conversion of the A/D converter 32 on each beat signal SB, and “N” is the number of samples of A/D conversion of the A/D converter 32 on each beat signal SB. Also, if the sampling frequency of the A/D conversion is represented by fs, the fundamental frequency Δfr of a distance bin fr can be expressed by Δfr=fs/N.

$$\begin{matrix}[ Expression 1 ] & \\ F ( fr ) = {\sum }_{x = 0}^{N - 1} f ( x ) {e}^{- i 2 κ \frac{fr \cdot x}{N}} & ( 1 )\end{matrix}$$

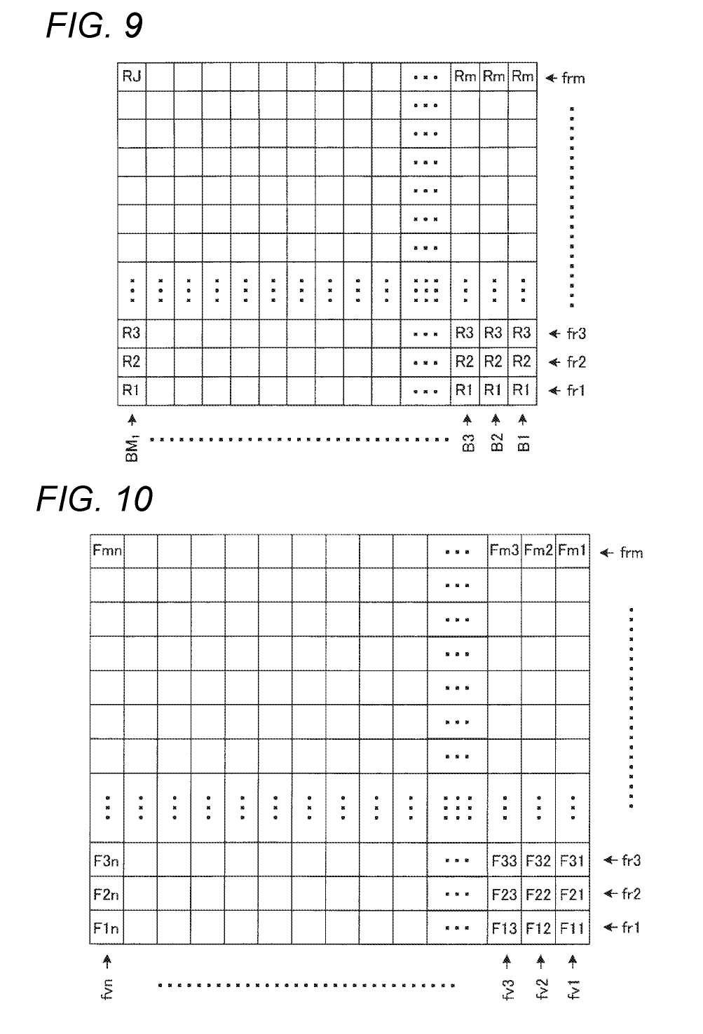

Therefore, (m×M₁)-number of FFT processes are performed (wherein m is the total number of distance bins fr and M₁ is the total number of beat signals SB), and the results of the FFT processes are stored in the storage unit 54. FIG. 9 is a view illustrating the relation between the distance bins fr1 to frm and the beat signals SB (B1 to BM₁). As shown in FIG. 9, FFT results (R1 to Rm shown in FIG. 9) of distance bins fr1 to frm of each beat signal SB are calculated, and the calculation results are stored in the storage unit 54. Also, R1 to Rm shown in FIG. 9 represent the power values (levels) of the beat signals SB of the distance bins fr1 to frm, respectively.

The results of FFT processes on the beat signals SB of the first transmission period T1 are for roughly grasping the distances and relative velocities of targets, and in order to decrease the velocity resolution, it is possible to reduce the total number M₁ of beat signals SB. In other words, it is possible to decrease the number of chirp waves of the first transmission period T1. Therefore, it is possible to suppress an increase in the memory capacity (usage) of the storage unit 54 for storing results of first FFT processes.

Thereafter, the first conversion process unit 51 performs second FFT processes on the results of the first FFT processes stored in the storage unit 54. In this case, the first conversion process unit 51 performs second FFT processes on velocity bins fv of each distance bin fr, respectively, and the results of the second FFT processes (hereinafter, also referred to as FFT process results) in the storage unit 54.

For example, the first conversion process unit 51 performs second FFT processes on individual velocity bins fv (fv1 to fvn) of each distance bin fr, respectively, by calculation of the following Expression 2. Also, “f (fr, y)” is the power value of the y-th beat signal SB at a distance bin fr, and “M₁” is the total number of beat signals SB of the first transmission period T1. Also, if the generation frequency of the beat signal SB is represented by fc (=1/Tc), the fundamental frequency (frequency resolution) Δfv of the velocity bin fv can be expressed by Δfv=fc/M₁.

$$\begin{matrix}[ Expression 2 ] & \\ F ( fr , fv ) = {\sum }_{y = 0}^{{M}_{1} - 1} f ( fr , y ) {e}^{- i \frac{2 π \cdot fv \cdot y}{{M}_{1}}} & ( 2 )\end{matrix}$$

Now, processing in the second processing mode will be described. In the second processing mode, similarly in the first processing mode, the first conversion process unit 51 performs first FFT processes on M₁-number of beat signals SB obtained in the first transmission period T1. Therefore, similarly in the first processing mode, it is possible to suppress an increase in the memory capacity of the storage unit 54 for storing the results of the first FFT processes. However, in the second processing mode, the first conversion process unit 51 does not perform second FFT processes on the results of the first FFT processes.

In the second processing mode, since estimates of the distances of targets are specified, but the relative velocities of the targets are not specified, as compared to the first processing mode, it is possible to reduce the number M₁ of chirp waves (the number of beat signals SB). Therefore, in the second processing mode, as compared to the first processing mode, it is possible to suppress an increase in the memory capacity of the storage unit 54 for storing the results of first FFT processes, and it is possible to reduce the first transmission period T1, thereby reducing the calculating time of the first conversion process unit 51.

[2.4.3.2. Distance/Relative-Velocity Calculating Unit 52]

The distance/relative-velocity calculating unit 52 acquires the FFT process results of the first conversion process unit 51 from the storage unit 54, and calculates the distances and relative velocities of targets, on the basis of the acquired FFT process results. The distance/relative-velocity calculating unit 52 specifies distance bins and velocity bins having predetermined values (levels) or more, as distance bins fr and velocity bins fv at which peaks exist, from the (m×n)-number of F (fr, fv) which are the FFT process results of the combinations of the distance bins and the velocity bins.

For example, in a case where the first conversion process unit 51 performs two-dimensional FFT processes according to the first processing mode, the distance/relative-velocity calculating unit 52 specifies the combinations of the distance bins and the velocity bins at which peaks exist, from the results of the two-dimensional FFT processes.

For example, from the (m×n)-number of combinations of distance bins and velocity bins, the distance/relative-velocity calculating unit 52 specifies combinations of distance bins and velocity bins at which there are peaks having a predetermined value or more, as combination of distance bins and velocity bins at which peaks exist. On the basis of the combinations of distance bins and velocity bins specified as combinations at which peaks exist, the distance/relative-velocity calculating unit 52 calculates the distances and relative velocities of targets.

Here, if the frequency of a distance bin fr at which a peak appears is represented by “f_{R}”, the distance of a target can be expressed by the following Expression 3. Also, in the following Expression 3, the frequency modulation width Δf of the transmission signal ST can be expressed by Δf=f1−f0, and the chirp period fm [Hz] can be expressed by fm=1/Tm (see FIG. 3). Also, “c” represents the speed of light.

$$\begin{matrix}[ Expression 3 ] & \\ zr = \frac{{f}_{R} \cdot c}{8 \cdot Δ f \cdot fm} & ( 3 )\end{matrix}$$

Also, if the frequency of a velocity bin fv at which a peak appears is represented by “fv”, the distance of a target can be expressed by the following Expression 4. Also, in the following Expression 4, “fc” represents the center frequency of the transmission signal, and can be expressed by fc=(f1−f0)/2. “Cn” represents the number of chirps, and in the first transmission period T1, Cn is equal to M₁.

$$\begin{matrix}[ Expression 4 ] & \\ zv = \frac{{f}_{V} \cdot c}{2 \cdot fc \cdot Cn \cdot Ts} & ( 4 )\end{matrix}$$

The distance/relative-velocity calculating unit 52 outputs information specifying the combinations of distance bins and velocity bins at which the peaks exist, or the calculation results of the above-mentioned Expressions 3 and 4, as the derivation results of the distance and relative velocities of targets.

However, in two-dimensional FFT processes corresponding to the beat signals SB of all of the receiving antennae 21, the same combinations of distance bins and velocity bins having the predetermined value or more may be obtained. For example, if the same combinations of distance bins and velocity bins having the predetermined value or more are obtained in two-dimensional FFT processes corresponding to beat signals SB of a predetermined number of receiving antennae 21 or more, the distance/relative-velocity calculating unit 52 can specify those combinations as combinations of distance bins and velocity bins at which peaks exist.

The distance/relative-velocity calculating unit 52 can specify a combination of a distance bin and a velocity bin having the predetermined value or more, as a combination of a distance bin and a velocity bin at which a peak exists, if the corresponding combination is adjacent to another combination of a distance bin and a velocity bin having the predetermined value or more.

Also, in a case where the first conversion process unit 51 performs one FFT process on each beat signal in the second processing mode, from the results of the corresponding FFT process, the distance/relative-velocity calculating unit 52 specifies distance bins at which peaks exist. For example, from (m×n)-number of combinations of distance bins and velocity bins, the distance/relative-velocity calculating unit 52 can specify distance bins having the predetermined value or more, as distance bins at which peaks exist. On the basis of the distance bins specified as bins at which peaks exist, the distance/relative-velocity calculating unit 52 calculates the distances of targets.

Also, the peak specifying method is the same as that in the first processing mode. In other words, in view of the relation of beat signals SB of the receiving antennae 21 in the second processing mode, the power values of neighboring distance bins, and so on, the distance/relative-velocity calculating unit 52 can specify distance bins at which peaks exist.

[2.4.3.3. Second Conversion Processing Unit 53]

On the basis of either the distances and the relative velocities or the distances derived by the distance/relative-velocity calculating unit 52, the second conversion processing unit 53 performs two-dimensional FFT processes on M₂-number of beat signals SB generated with respect to each receiving antenna 21 in the second transmission period T2 by the generating unit 30. The second conversion processing unit 53 stores the results of the two-dimensional FFT processes in the storage unit 54.

In the case where the processing unit 40 is in the first processing mode, the second conversion processing unit 53 performs two-dimensional FFT processes on a range Arv (hereinafter, also referred to as a limited range Arv) limited by the distances and the relative velocities derived by the distance/relative-velocity calculating unit 52. Also, in the case where the processing unit 40 is in the second processing mode, the second conversion processing unit 53 performs two-dimensional FFT processes on a range Ar (hereinafter, also referred to as a limited range Ar) limited by the distances derived by the distance/relative-velocity calculating unit 52.

First, the case of the first processing mode will be described. In the first processing mode, the second conversion processing unit 53 performs two-dimensional FFT processes on M₂-number of beat signals SB by calculation of the following Expression 5.

$$\begin{matrix}[ Expression 5 ] & \\ F ( fr , fv ) = {\sum }_{x = 0}^{N - 1} {\sum }_{y = 0}^{{M}_{2} - 1} f ( x , y ) {e}^{- i 2 π ( \frac{fr \cdot x}{N} + \frac{fv \cdot y}{{M}_{2}} )} & ( 5 )\end{matrix}$$

In the above-mentioned Expression 5, “F(fr, fv)” represents the result of the process on one combination of a distance bin and a velocity bin. FIG. 10 is a view illustrating the relation between the distance bins fr1 to frm and the velocity bins fv1 to fvn, and shows the results of two-dimensional FFT processes on the combinations of the distance bins fr and the velocity bins fv, as F11 to Fmn. In other words, F11 to Fmn shown in FIG. 10 represent the power values of the signals at the combinations of the individual distance bins fr1 to frm and the individual velocity bins fv1 to fvn. For example, the power value of the signal at the combination of the distance bin fr1 and the velocity bin fv1 is F(fr1, fv1), and in FIG. 10, F(fr1, fv1) is represented by F11.

When the results of the two-dimensional FFT processes on all of the combinations of the distance bins fr and the velocity bins fv obtained by calculation of the above-mentioned Expression 5 are stored in the storage unit 54, (m×n)-number of two-dimensional FFT process results are stored in the storage unit 54 (wherein m represents the total number of the distance bins fr and n represents the total number of the velocity bins fv).

Then, the second conversion processing unit 53 determines the limited range Arv including combinations Prv (hereinafter, referred to as peak positions Prv) of distance bins fr and velocity bins fv corresponding to combinations of the distances and the relative velocities derived by the distance/relative-velocity calculating unit 52. Subsequently, the second conversion processing unit 53 performs two-dimensional FFT processes on M2-number of beat signals SB only in the limited range Arv, and stores the results of the two-dimensional FFT processes in the storage unit 54.

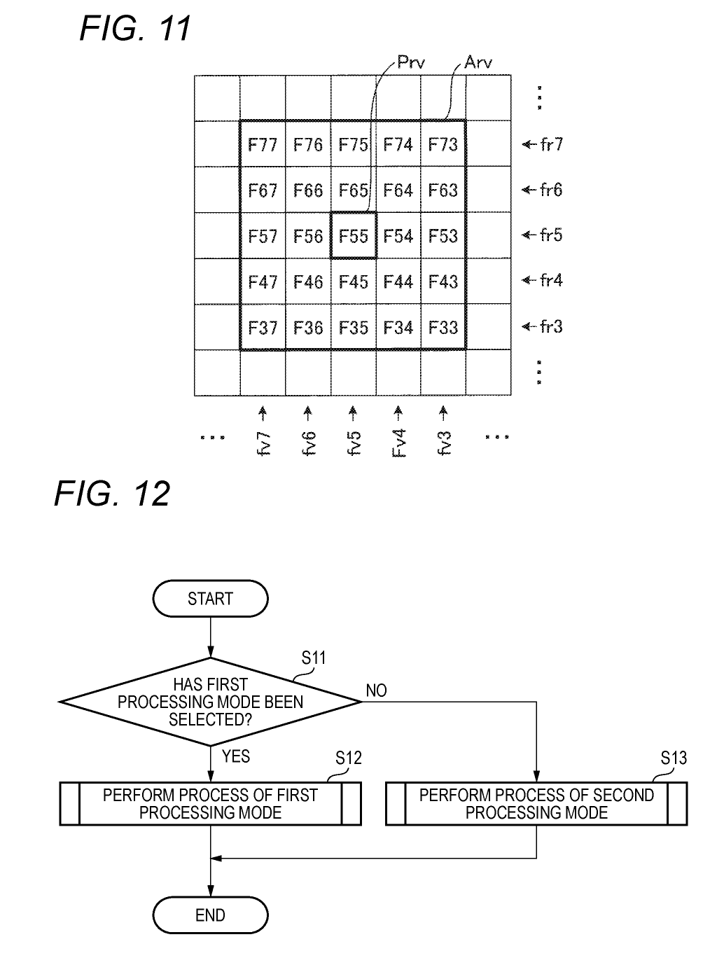

FIG. 11 is a view illustrating the relation between a peak position Prv and a limited range Arv. In the example shown in FIG. 11, the peak position Prv is a combination of a distance bin fr5 and a velocity bin fv5, and the limited range Arv is a range including combinations of distance bins fr3 to fr7 and velocity bins fv3 to fv7.

In a case where there is only one peak position Prv, the second conversion processing unit 53 performs two-dimensional FFT processes only on the limited range Arv (for example, 25 combinations) shown in FIG. 11. In other words, the second conversion processing unit performs two-dimensional FFT processes only on the range including the peak position Prv (the range of 5 distance bins fr by 5 velocity bins fv). Therefore, even if the second transmission period T2 is lengthened, and the number M₂ of chirps is increased, it is possible to suppress an increase in the memory capacity of the storage unit 54 for storing calculation results of two-dimensional FFT processes of the second conversion processing unit 53.

Also, since the second conversion processing unit 53 performs two-dimensional FFT processes only on a limited range Arv whenever a beat signals SB is acquired, and integrates the results of the two-dimensional FFT processes, it is possible to obtain the final results of the two-dimensional FFT processes on the limited range Arv. Therefore, it becomes unnecessary a process of saving data on all beat signals SB in a memory before two-dimensional FFT processes, and thus it is possible to reduce the memory capacity. Also, integration of the results of the two-dimensional FFT processes is performed on every combination of a distance bin fr and a velocity bin fv in the limited range Arv.

Also, in the example shown in FIG. 11, a range of distance bins fr and velocity bins fv having distances of two bins or less from the peak position Prv is set as a limited range Arv; however, the present invention is not limited thereto. For example, the second conversion processing unit 53 can set a range of distance bins fr and velocity bins fv having a predetermined distance or less from the peak position Prv (wherein the predetermined distance may be one bin, or three or more bins), as a limited range Arv. Also, the second conversion processing unit 53 can also set, for example, a part the limited range Arv of FIG. 11 except for “F33”, “F37”, “F73”, and “F77”, as a limited range Arv.

Also, in the first processing mode, the second conversion processing unit 53 can determine a limited range Ar from a distance bin (hereinafter, referred to as a peak position Pr corresponding to a distance derived by the distance/relative-velocity calculating unit 52, and perform calculation of the above-mentioned Expression 1 on the limited range Ar. For example, in a case where the peak position Pr is the distance bin fr5, the limited range Ar is a range of distance bins fr3 to fr7.

Therefore, it is possible to reduce the number of first FFT processes, and it is possible to suppress an increase in the memory capacity of the storage unit 54 for storing the results of first FFT processes. Also, the second conversion processing unit 53 can set a range of distance bins fr having a predetermined distance or less from the peak position Pr (wherein the predetermined distance may be one bin, or three or more bins), as a limited range Ar.

Also, the second conversion processing unit 53 can determine a limited range Av from a velocity bin corresponding to a distance derived by the distance/relative-velocity calculating unit 52, and perform calculation of the following Expression 6 on the results of calculation of the above-mentioned Expression 1 corresponding to a limited range Avr including the limited range Av and the limited range Ar.

$$\begin{matrix}[ Expression 6 ] & \\ F ( fr , fv ) = {\sum }_{y = 0}^{{M}_{2} - 1} f ( fr , y ) {e}^{- i \frac{2 π \cdot fv \cdot y}{{M}_{2}}} & ( 6 )\end{matrix}$$

The limited range Av is, for example, a range of velocity bins fv having distances of a predetermined number of bins or less from a velocity bin (hereinafter, referred to as a peak position Pv) corresponding to a velocity derived by the distance/relative-velocity calculating unit 52. In a case where the peak position Pv is the velocity bin fv5, the limited range Av is a range of velocity bins fv3 to fv7.

Therefore, it is possible to reduce the number of second FFT processes to the number of times corresponding to the limited range Arv, and it is possible to suppress an increase in the memory capacity of the storage unit 54 for storing the results of the second FFT processes. Also, the second conversion processing unit 53 can set a range of distance bins fv having a predetermined distance or less from the peak position Pv (wherein the predetermined distance may be one bin, or three or more bins), as a limited range Av.

Now, the case of the second processing mode will be described. In the second processing mode, the second conversion processing unit 53 determines a limited range Ar on the basis of a distance bin corresponding to a distance derived by the distance/relative-velocity calculating unit 52, and performs calculation of the above-mentioned Expression 1 on the determined limited range Ar.

The limited range Ar is, for example, a range of distance bins fr having distances of a predetermined number of bins or less from a distance bin (hereinafter, referred to as a peak position Pr) corresponding to a distance derived by the distance/relative-velocity calculating unit 52. For example, in a case where the peak position Pr is the distance bin fr5, the limited range Ar is a range of distance bins fr3 to fr7. In the limited range Ar, velocity bins fv are not limited, and with respect to the distance bins fr3 to fr7, velocity bins fv are the full range (fv1 to fvn).

Even in this case, it is possible to reduce the number of first FFT processes, and it is possible to suppress an increase in the memory capacity of the storage unit 54 for storing the results of the first FFT processes. Also, the second conversion processing unit 53 can set a range of distance bins fr having a predetermined distance or less from the peak position Pr (wherein the predetermined distance may be one bin, or three or more bins), as a limited range Ar.

Subsequently, the second conversion processing unit 53 performs calculation of the above-mentioned Expression 6 on the results of calculation of the above-mentioned Expression 1 corresponding to the limited range Ar. Therefore, if the number of distance bins fr in the limited range Ar is set to m1, it is possible to reduce the data amount of the results of second FFT processes to m1/m times the data amount in a case of performing calculation object the above-mentioned Expression 6 on the full range of the distance bins fr1 to frm and the velocity bins fv1 to fvn.

For example, in a case where the distance bins fr in the limited range Ar are the distance bins fr3 to fr7, the second conversion processing unit 53 performs calculation of the above-mentioned Expression 6 only on a range of combinations of the distance bins fr3 to fr7 and the velocity bins fv1 to fvn. Therefore, it is possible to reduce the number of the results of second FFT processes from (m×n) to (5×n). Therefore, it is possible to suppress an increase in the memory capacity of the storage unit 54 for storing the results of second FFT processes.

Also, the second conversion processing unit 53 can set a wider limited range Ar and a wider limited range Arv as M₁ which is the number of chirps in the first transmission period T1 decreases, and set a narrower limited range Ar and a narrower limited range Arv as M₁ which is the number of chirps increases.

Also, the second conversion processing unit 53 can change the sizes of the limited range Ar and the limited range Arv, on the basis of the target detection state of the radar device 1 (for example, the number of targets and the sizes of targets), the running state of the vehicle A (for example, the velocity of the vehicle A and the type of the road where the vehicle is running), and so on. Also, the second conversion processing unit 53 can change the sizes of the limited range Ar and the limited range Arv, on the basis of contents input to the input unit (not shown in the drawings) and the state of the surroundings of the vehicle (for example, weather and a road congestion situation).

Also, in a case where the derivation result of the distance/relative-velocity calculating unit 52 is a combination of a distance bin and a velocity bin at which a peak exists, not the distance and relative velocity of a target, the second conversion processing unit specifies a limited range Arv on the basis of the corresponding combination. For example, the second conversion processing unit 53 can set a combination of a distance bin and a velocity bin at which peaks exist, as a peak position Pv. Here, when one is referred to as corresponding to another one, it may match with or be included in another one. Also, similarly, in a case where the derivation result of the distance/relative-velocity calculating unit 52 is a distance bin at which a peak exists, not the distance of a target, it is possible to specify a limited range Ar on the basis of the derived distance bin.

[2.4.4. Peak Extracting Unit 45]

The peak extracting unit 45 acquires the results of the second FFT processes of the second conversion processing unit 53 from the storage unit 54, and specifies distance bins and velocity bins at which peaks exist, on the basis of the acquired second FFT process results. The peak extracting unit 45 can specify distance bins and velocity bins which have the predetermined value or more as distance bins and velocity bins at which peaks exist, from (m×n)-number of FFT process results F(fr, fv) corresponding to the individual combinations of distance bins and velocity bins.

Also, the peak extracting unit 45 specifies distance bins and velocity bins at which peaks exist, from the results of the two-dimensional FFT processes in the same way as that of the distance/relative-velocity calculating unit 52.

[2.4.5. Azimuth Calculating Unit 46]

The azimuth calculating unit 46 separates information on a plurality of targets existing at the same distance bin, from signals of the individual distance bins specified as bines by the peak extracting unit 45, and estimates the angles of the plurality of targets. With a focus on the signals (hereinafter, referred to as peak signals) of the same peak frequency bins in the frequency spectra of all of four beat signals SB based on the reception signals SR of four receiving antennae 21, the azimuth calculating unit 46 estimates the angels of the targets on the basis of the phase information of the peak signals. The azimuth calculating unit 46 performs azimuth estimation using an azimuth estimating system such as ESPRIT (Estimation of Signal Parameters via Rotational Invariance Techniques), DBF (Digital Beam Forming), or MUSIC (Multiple Signal Classification).

[2.4.6. Distance/Relative-Velocity Calculating Unit 47]

The distance/relative-velocity calculating unit 47 derives the distances and relative velocities of targets on the basis of the combinations of distance bins and velocity bins specified as bins at which peaks exist by the peak extracting unit 45.

For example, the distance/relative-velocity calculating unit 47 can derive the distances of targets by calculation of the above-mentioned Expression 3. Also, the distance/relative-velocity calculating unit 47 can derive the velocities of the targets by calculation of the above-mentioned Expression 4. Also, in the above-mentioned Expression 4, Cn is equal to M₂.

In the above-described example, the peak extracting unit 45 and the distance/relative-velocity calculating unit 47 have been individually described. However, the distance/relative-velocity calculating unit 47 may be configured to include the peak extracting unit 45, or may be configured to include the azimuth calculating unit 46.

Also, in the above description, the FCM type radar device 1 has been described as an example. However, the radar device 1 is not limited to a FCM type radar device. In other words, the radar device 1 may be a radar device capable of limiting distances and relative velocities when deriving distances and relative velocities, thereby improving the accuracy of target detection while suppressing an increase in the memory capacity of the memory for a target detecting process.

[3. Processing Performed by Processing Unit 40]

Now, an example of the flow of processing which is performed by the processing unit 40 of the radar device 1 will be described with reference to a flow chart. FIG. 12 is a flow chart illustrating an example of the procedure of processing which is performed by the processing unit 40, and shows processing which is repeatedly performed.

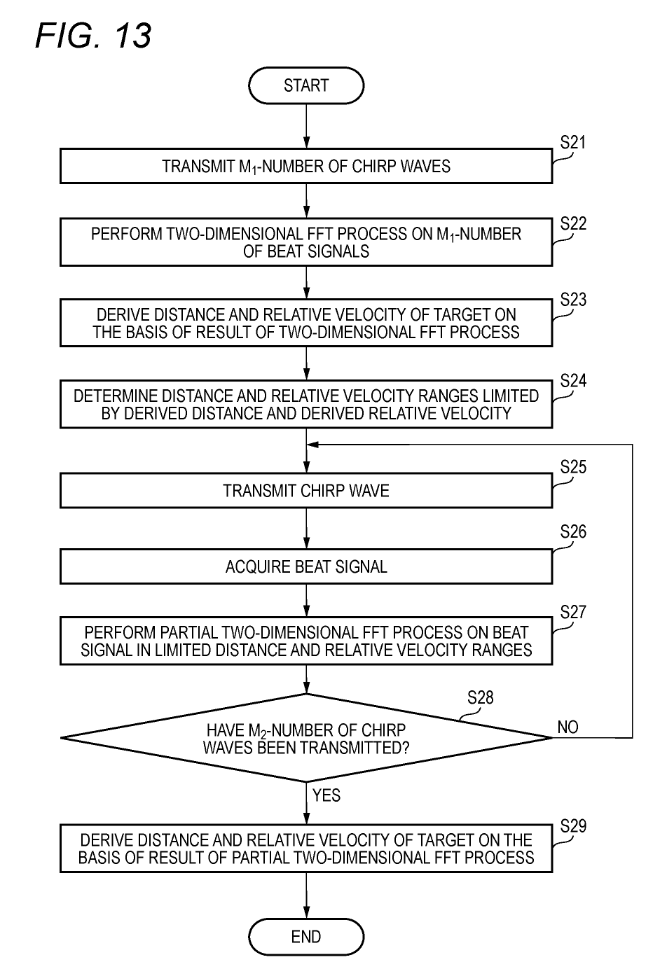

As shown in FIG. 12, in STEP S11, the processing unit 40 determines whether the first processing mode has been selected. In a case of determining that the first processing mode has been selected (“Yes” in STEP S11), in STEP S12, the profile generating unit 116 performs the processing of the first processing mode. The process of STEP S12 is processing of STEPS S21 to S29 shown in FIG. 13, and will be described below.

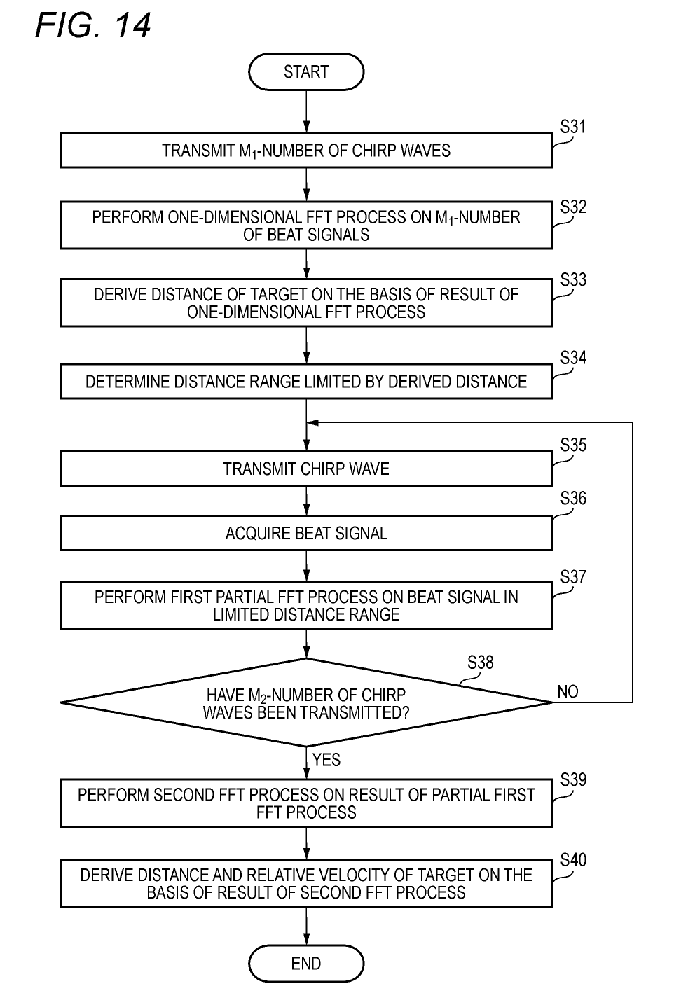

Meanwhile, in a case of determining that the first processing mode has not been selected (“No” in STEP S11), in STEP S13, the processing unit 40 performs the process of the second processing mode. The process of STEP S13 is processing of STEPS S31 to S40 shown in FIG. 14, and will be described below.

FIG. 13 is a flow chart illustrating an example of the flow of the process of STEP S12 shown in FIG. 12. As shown in FIG. 13, in STEP S21, the processing unit 40 controls the transmitting unit 10 such that the transmitting unit transmits M₁-number of chirp waves in the first transmission period T1. In STEP S22, the processing unit 40 performs two-dimensional FFT processes on M₁-number of beat signals SB generated in the first transmission period T1 by the generating unit 30.

On the basis of the results of the two-dimensional FFT processes of STEP S22, the processing unit 40 derives the distances and relative velocities of targets in STEP S23, and determines a limited range Arv which is a range of distances and relative velocities limited by the derived distances and the derived relative velocities, in STEP S24.

Subsequently, the processing unit 40 controls the transmitting unit 10 in STEP S25 such that the transmitting unit transmits one chirp wave in the second transmission period T2, and acquires one beat signal generated by the generating unit 30, in STEP S26. In STEP S27, the processing unit 40 performs a partial two-dimensional FFT process on one beat signal SB acquired in STEP S26 from the limited range Arv which is the range of distances and relative velocities limited in STEP S24.

As described above, the processing unit 40 does not perform two-dimensional FFT processes after acquiring all of beat signals SB based on a plurality of (for example, 256) chirp waves, but integrates the calculation result of a two-dimensional FFT process whenever a beat signal SB based on one chirp wave is acquired. Therefore, it becomes unnecessary to save a plurality of (for example, 256) data items having not been subjected to two-dimensional FFT processes, in a memory, and thus it is possible to reduce the memory capacity. Also, this calculation is performed by the above-mentioned Expression 5.

In STEP S28, the processing unit 40 determines whether M₂-number of chirp waves have been transmitted from the transmitting unit 10. In a case where M₂-number of chirp waves have not been transmitted from the transmitting unit 10 (“No” in STEP S28), the processing proceeds to STEP S25.

Meanwhile, in a case where M₂-number of chirp waves have been transmitted from the transmitting unit 10 (“Yes” in STEP S28), in STEP S29, on the basis of the results of partial two-dimensional FFT processes, the processing unit 40 derives the distances and relative velocities of targets. Then, the processing unit finishes the processing shown in FIG. 13, and repeats the process from STEP S11 of FIG. 12, with a predetermined period.

FIG. 14 is a flow chart illustrating an example of the flow of the process of STEP S13 shown in FIG. 12. As shown in FIG. 14, in STEP S31, the processing unit 40 controls the transmitting unit 10 such that the transmitting unit transmits M₁-number of chirp waves in the first transmission period T1. In STEP S32, the processing unit 40 performs one-dimensional FFT processes on M₁-number of beat signals generated in the first transmission period T1 by the generating unit 30.

In STEP S33, the processing unit 40 derives the distance of a target on the basis of the results of the one-dimensional FFT processes of STEP S32. Then, in STEP S34, the processing unit determines a limited range Ar which is a distance range limited by the derived distance.

Subsequently, the processing unit 40 controls the transmitting unit 10 in STEP S35 such that the transmitting unit transmits one chirp wave in the second transmission period T2, and acquires one beat signal generated by the generating unit 30, in STEP S36. In STEP S37, the processing unit 40 performs a partial first FFT process on the one beat signal SB acquired in STEP S36, in the limited range Ar which is the distance range limited in STEP S34.

In STEP S38, the processing unit 40 determines whether M₂-number of chirp waves have been transmitted from the transmitting unit 10. In a case where M₂-number of chirp waves have not been transmitted from the transmitting unit 10 (“No” in STEP S38), the processing proceeds to STEP S35.

Meanwhile, in a case where M₂-number of chirp waves have been transmitted from the transmitting unit 10 (“Yes” in STEP S38), in STEP S39, the processing unit 40 performs a second FFT process on the result of the partial first FFT process. Subsequently, the processing unit 40 derives the distance and relative velocity of the target on the basis of the result of the second FFT process, in STEP S40, and finishes the processing shown in FIG. 14, and repeats the processing from STEP S11 with a predetermined period.

As described above, the radar device 1 according to the embodiment includes the transmitting unit 10, the receiving unit 20, the transmission control unit 41, the generating unit 30, and the signal processing unit 43. The transmitting unit 10 transmits chirp waves according to the transmission signal ST whose frequency continuously increases or decreases. The receiving unit 20 outputs reception signals SR based on reflected waves of the chirp waves from a target. The transmission control unit 41 controls the transmitting unit 10 in the first transmission period T1 such that the transmitting unit transmits a predetermined number of chirp waves, and then controls the transmitting unit 10 in the second transmission period T2 such that the transmitting unit transmits chirp waves more than the predetermined number. The generating unit 30 generates beat signals SB from the transmission signal ST and the reception signals SR. The signal processing unit 43 derives the distance of the target on the basis of the beat signals SB generated in the first transmission period T1 by the generating unit 30, and derives the distance and relative velocity of the target on the basis of the beat signals SB generated in the second transmission period T2 by the generating unit 30, in a distance range limited by the derived distance (the limited range Ar or Arv). In the second transmission period T2, since a lot of chirp waves are transmitted, the number of beat signals SB which are obtained by one time of detection increases. Therefore, in the second transmission period T2, as compared to the first transmission period T1, it is possible to acquire more information on the distance and relative velocity of the target, and it is possible to detect an accurate distance bin fr and an accurate velocity bin fv at which a peak exists. Also, in the first transmission period T1, every distance bin fr and every velocity bin fv are search objects; whereas in the second transmission period T2, limited distance bins fr and velocity bins fv surrounding a searched peak position are search objects. Therefore, even in a case where the number of chirp waves in the second transmission period T2 is increased to improve the accuracy of target detection, it is possible to suppress an increase in usage of the storage unit 54 for the target detecting process and a processing load on the processing unit 40.

Also, in the first transmission period T1, the signal processing unit 43 derives not only the distance of a target but also the relative velocity of the target on the basis of beat signals SB generated by the generating unit 30. In the second transmission period T2, the signal processing unit derives the distance and relative velocity of the target on the basis of beat signals SB generated by the generating unit 30, in a range of distances and relative velocities limited by the derived distance and the derived relative velocity. As described above, since not only the distance range but also the relative velocity range is limited, and the distance and relative velocity of the target are derived on the basis of the beat signals SB, even in a case where the number of chirp waves in the second transmission period T2 is increased to improve the accuracy of target detection, it is possible to further suppress an increase in usage of the storage unit 54 for the target detecting process.

Also, the signal processing unit 43 includes the first conversion process unit 51 (an example of the first processing unit), the distance/relative-velocity calculating unit 52 (an example of the first deriving unit), the second conversion processing unit 53 (an example of the second processing unit), and the distance/relative-velocity calculating unit 47 (an example of a second deriving unit). The first conversion process unit 51 performs FFT processes on beat signals SB output from the generating unit 30 in the first transmission period T1. On the basis of the results of the FFT processes of the first conversion process unit 51, the distance/relative-velocity calculating unit 52 derives the distance of a target. The second conversion processing unit 53 acquires the results of two-dimensional FFT processes on beat signals SB output from the generating unit 30 in the second transmission period T2, in a distance range (a limited range Ar) limited by the distance derived by the distance/relative-velocity calculating unit 52. On the basis of the results of the two-dimensional FFT processes of the second conversion processing unit 53, the distance/relative-velocity calculating unit 47 derives the distance and relative velocity of the target. As described above, since the results of the two-dimensional FFT processes are acquired by the limited distance range, even in a case where the second transmission period T2 is lengthened and M₂ which is the number of chirp waves is increased in order to improve the accuracy of target detection, it is possible to suppress an increase in the memory capacity (usage) of the storage unit 54 for storing the calculation results of two-dimensional FFT processes of the second conversion processing unit 53. Also, the results of the FFT processes of the first conversion process unit 51 are information on the frequency spectra of the beat signals SB, and include information on the power values of the beat signals SB at the individual distance bins fr. Also, the results of the two-dimensional FFT processes of the second conversion processing unit 53 are information representing the frequency spectra which are frequency distributions showing temporal variations of the power values of the beat signals SB of the distance bins fr in the frequency spectra of a plurality of temporally consecutive beat signals, and include information on the value (level) of each velocity bin fv with at each distance bin fr.

Also, the first conversion process unit 51 can perform two-dimensional FFT processes on the beat signals SB output from the generating unit 30 in the first transmission period T1. On the basis of the results of the two-dimensional FFT processes of the first conversion process unit 51, the distance/relative-velocity calculating unit 52 derives the distance and relative velocity of a target. The second conversion processing unit 53 acquires the results of a two-dimensional FFT processes on beat signals SB output from the generating unit 30 in the second transmission period T2, in a range of distances and relative velocities limited by the distance derived by the distance/relative-velocity calculating unit 52. On the basis of the results of the two-dimensional FFT processes of the second conversion processing unit 53, the distance/relative-velocity calculating unit 47 derives the distance and relative velocity of the target. As described above, since the results of the two-dimensional FFT processes in the limited distance range are acquired and the limited relative velocity range, even in a case where the second transmission period T2 is lengthened and M₂ which is the number of chirp waves is increased in order to improve the accuracy of target detection, it is possible to further suppress an increase in the memory capacity (usage) of the storage unit 54 for storing the calculation results of two-dimensional FFT processes of the second conversion processing unit 53. Also, the results of the two-dimensional FFT processes of the first conversion process unit 51 and the second conversion processing unit 53 are information representing the frequency spectra which are frequency distributions showing temporal variations of the power values of the beat signals SB at the distance bins fr in the frequency spectra of a plurality of temporally consecutive beat signals, and include information on the value (level) of each velocity bin fv at each distance bin fr.

Various advantages and modifications can be easily achieved by those skilled in the art. Therefore, the invention in its broader aspects is not limited to the specific details and representative embodiments shown and described above. Accordingly, various modifications may be made without departing from the spirit or scope of the general inventive concept as defined by the appended claims and their equivalents.

What is claimed is:

1. A radar device comprising:
a transmitting unit configured to transmit chirp waves on the basis of a transmission signal whose frequency continuously increases or decreases;
a receiving unit configured to output reception signals based on reflected waves of the chirp waves from a target;
a transmission control unit configured to control the transmitting unit to transmit a predetermined number of the chirp waves in a first transmission period, and then control the transmitting unit to transmit the chirp waves more than the predetermined number in a second transmission period;
a generating unit configured to generate beat signals from the transmission signal and the reception signals; and
a signal processing unit configured to derive a distance to the target on the basis of the beat signals generated in the first transmission period by the generating unit, determine a distance range limited on the basis of the derived distance, and derive the distance and a relative velocity to the target on the basis of the beat signals generated in the second transmission period by the generating unit within the distance range.

2. The radar device according to claim 1, wherein the signal processing unit derives the relative velocity to the target in addition to the distance to the target on the basis of the beat signals generated in the first transmission period by the generating unit, determine a relative velocity range limited on the basis of the derived relative velocity, and derives the distance and the relative velocity to the target on the basis of the beat signals generated in the second transmission period by the generating unit within the distance range and the relative velocity range.

3. The radar device according to claim 1, wherein the signal processing unit includes:
a first processing unit configured to perform FFT processes on the beat signals output from the generating unit in the first transmission period;
a first deriving unit configured to derive the distance to the target on the basis of results of the FFT processes of the first processing unit;
a second processing unit configured to perform two-dimensional FFT processes on the beat signals output from the generating unit in the second transmission period within the distance range limited on the basis of the distance derived by the first deriving unit; and
a second deriving unit configured to derive the distance and the relative velocity to the target on the basis of results of the two-dimensional FFT processes of the second processing unit.

4. The radar device according to claim 2, wherein the signal processing unit includes:
a first processing unit configured to perform two-dimensional FFT processes on the beat signals output from the generating unit in the first transmission period;
a first deriving unit configured to derive the distance and the relative velocity to the target on the basis of results of the two-dimensional FFT processes of the first processing unit;
a second processing unit configured to perform two-dimensional FFT processes on the beat signals output from the generating unit in the second transmission period within the distance and relative velocity ranges limited on the basis of the distance and the relative velocity derived by the first deriving unit; and
a second deriving unit configured to derive the distance and the relative velocity to the target on the basis of results of the two-dimensional FFT processes of the second transmission period.

5. A target detecting method comprising:
a first transmitting process of transmitting a predetermined number of chirp waves in a first transmission period on the basis of a transmission signal whose frequency continuously increases or decreases at a predetermined interval;
a first outputting process of outputting reception signals based on reflected waves of the chirp waves from a target in the first transmission period;
a first generating process of generating beat signals from the transmission signal and the reception signals in the first transmission period;
a first deriving process of deriving a distance to the target on the basis of the beat signals generated in the first transmission period;
a second transmitting process of transmitting chirp waves more than the predetermined number in a second transmission period after the first transmission period on the basis of the transmission signal whose frequency continuously increases or decreases at the predetermined interval;
a second outputting process of outputting reception signals based on reflected waves of the chirp waves from the target in the second transmission period;
a second generating process of generating beat signals from the transmission signal and the reception signals in the second transmission period; and
a second deriving process of deriving the distance and a relative velocity to the target on the basis of the beat signals generated in the second transmission period in the second generating process within a distance range limited on the basis of the distance derived in the first deriving process.
